(19) United States
(12) Patent Application Publication
(10) Pub. No.: US 2011/0122350 A1
(43) Pub. Date: May 26, 2011

(54) LIQUID CRYSTAL DISPLAY DEVICE

(76) Inventors: Kunihiro Tashiro, Osaka (JP); Takahiro Sasaki, Osaka (JP)

(21) Appl. No.: 12/991,975

(22) PCT Filed: May 1, 2009
(86) PCT No.: PCT/JP2009/001985

§ 371 Date: Feb. 7, 2011

(30) Foreign Application Priority Data
May 12, 2008 (JP) 2008-124710 2008

(51) Int. Cl. G02F 1/1337

(52) U.S. Cl. 349/123

(57) ABSTRACT

A PSA-type liquid crystal display device is provided in which occurrence of display unevenness due to the nonuniformity of the spreading speed of the liquid crystal material during its injection is prevented.

A liquid crystal display device of the present invention includes: a liquid crystal layer; a pair of electrodes opposing each other with the intervention of the liquid crystal layer; a pair of alignment films which are respectively provided between the pair of electrodes and the liquid crystal layer; and an alignment sustaining layer formed of a photopolymerized material on respective surfaces of the pair of alignment films which are closer to the liquid crystal layer. The alignment sustaining layer is configured to regulate a pretilt azimuth of a liquid crystal molecule of the liquid crystal layer when no voltage is applied across the liquid crystal layer. The liquid crystal display device of the present invention further includes a seal portion that surrounds the liquid crystal layer. The seal portion has a plurality of injection holes in its one side portion for injecting a liquid crystal material into a region surrounded by the seal portion. The plurality of injection holes are two injection holes by which the one side portion of the seal portion is divided into three parts. Where the three parts of the one side portion have length L1, length L2, and length L3 from one end thereof, the two injection holes are positioned such that L2 is not less than one time respective one of L1 and L3 and is less than two times respective one of L1 and L3.

### TECHNICAL FIELD

The present invention relates to a liquid crystal display device and specifically to a PSA-type liquid crystal display device.

### BACKGROUND ART

Liquid crystal display devices perform display by utilizing the change of the orientations of liquid crystal molecules which is caused in accordance with the level of a voltage applied across the liquid crystal layer. The orientations of the liquid crystal molecules which occur in the absence of an applied voltage across the liquid crystal layer (which are referred to as “pretilt directions”) are conventionally regulated by alignment films. For example, in TN (twisted nematic) mode liquid crystal display devices, the pretilt directions of the liquid crystal molecules are regulated by rubbed horizontal alignment films.

The pretilt direction is expressed by the pretilt azimuth and the pretilt angle. The pretilt azimuth refers to a component of a vector that is indicative of the orientation of a liquid crystal molecule in the liquid crystal layer in the absence of an applied voltage, the component being in a plane of the liquid crystal layer (in a plane of the substrate). The pretilt angle is an angle formed by the alignment film and the liquid crystal molecule and is determined depending primarily on a combination of the alignment film material and the liquid crystal material. In TN-mode liquid crystal display devices, the pretilt azimuths regulated by a pair of alignment films which oppose each other with the intervention of the liquid crystal layer are set perpendicular to each other. The pretilt angle is about 1° to 5°.

In recent years, as a technology for controlling the pretilt directions of the liquid crystal molecules, the PSA (Polymer Sustained Alignment) technology has been developed. The PSA technology is, for example, disclosed in Patent Documents 1 and 2. In the PSA technology, the pretilt directions of the liquid crystal molecules are controlled by means of a polymer formed in the liquid crystal layer. The polymer is formed by irradiating, after assemblage of a liquid crystal cell, a small amount of polymerizable material (e.g., a photopolymerizable monomer) mixed in a liquid crystal material with active energy rays (e.g., ultraviolet light) while a predetermined voltage is applied across the liquid crystal layer. The orientations of the liquid crystal molecules maintained during the formation of the polymer are sustained (memorized) even after removal of the voltage (in the absence of an applied voltage). Thus, the PSA technology is advantageously capable of adjusting the pretilt azimuths and pretilt angles of the liquid crystal molecules by controlling, for example, an electric field generated in the liquid crystal layer. Also, the PSA technology does not require a rubbing process and is therefore suitable to formation of a vertical alignment type liquid crystal layer that has difficulty in regulating the pretilt directions by means of a rubbing process.

In fabrication of a PSA-type liquid crystal display device, as understood from the above, it is necessary to inject a liquid crystal material that contains a polymerizable material into a region surrounded by the seal portion. The seal portion has at least one injection hole for the injection of the liquid crystal material. The arrangement of the injection holes in the seal portion of a conventional liquid crystal display device is disclosed in, for example, Patent Document 3.

The arrangement disclosed in Patent Document 3 is shown in FIG. 9. A liquid crystal display device 600 shown in FIG. 9 includes a liquid crystal layer 42 and a seal portion 50 that surrounds the liquid crystal layer 42. One side of the seal portion 50 that is in a rectangular shape has a plurality of injection holes 51. Each of the injection holes 51 is sealed up by a sealing portion 60. Note that Patent Document 3 discloses a space control member extending from the outer end to the inner end of the injection hole 51. However, the space control member does not affect the description provided below and is therefore not shown in FIG. 9.

### CITATION LIST

### Patent Literature

Patent Document 1: Japanese Laid-Open Patent Publication No. 2002-357830
Patent Document 2: Japanese Laid-Open Patent Publication No. 2003-307720
Patent Document 3: Japanese Patent Publication for Opposition No. 7-92572

### SUMMARY OF INVENTION

### Technical Problem

However, it was found that, when the conventional arrangement of the injection holes in the seal portion is applied to a PSA-type device, the display quality degrades. Specifically, as shown in FIG. 10, display unevenness occurs as if linearly-extending uneven regions divided the display region. Also, as shown in FIG. 10, display unevenness occurs near a side opposite to the side that has the injection holes. It is estimated that such display unevenness may occur due to the causes that will be described below.

When the liquid crystal material is injected from the injection holes, the spreading speed of the injected liquid crystal material is not constant but nonuniform across the display region. Therefore, in some parts of the display region, the liquid crystal material stays there without flowing so that the polymerizable material and impurities are disadvantageously adsorbed by the surfaces of the alignment films. As a result, in such regions, the liquid crystal molecules have different pretilt angles from those of the other regions, so that display unevenness disadvantageously occurs. Thus, the optimum arrangement of the injection holes for PSA-type devices has not already been determined.

The present invention was conceived in view of the above problems. One of the objects of the present invention is to provide a PSA-type liquid crystal display device in which occurrence of display unevenness due to the nonuniformity of the spreading speed of the liquid crystal material during its injection is prevented.

### Solution to Problem

A liquid crystal display device of the present invention includes: a liquid crystal layer; a pair of electrodes opposing each other with the intervention of the liquid crystal layer; a pair of alignment films which are respectively provided between the pair of electrodes and the liquid crystal layer; an alignment sustaining layer formed of a photopolymerized material on respective surfaces of the pair of alignment films which are closer to the liquid crystal layer, the alignment sustaining layer being configured to regulate a pretilt azimuth of a liquid crystal molecule of the liquid crystal layer when no voltage is applied across the liquid crystal layer; and a seal portion surrounding the liquid crystal layer, wherein the seal portion has a plurality of injection holes in its one side portion for injecting a liquid crystal material into a region surrounded by the seal portion, the plurality of injection holes are two injection holes by which the one side portion of the seal portion is divided into three parts, and where the three parts of the one side portion have length L1, length L2, and length L3 from one end thereof, the two injection holes are positioned such that L2 is not less than one time respective one of L1 and L3 and is less than two times respective one of L1 and L3.

In a preferred embodiment, the length L1, the length L2, and the length L3 of the three parts are generally equal to one another.

Another liquid crystal display device of the present invention includes: a liquid crystal layer; a pair of electrodes opposing each other with the intervention of the liquid crystal layer; a pair of alignment films which are respectively provided between the pair of electrodes and the liquid crystal layer; an alignment sustaining layer formed of a photopolymerized material on respective surfaces of the pair of alignment films which are closer to the liquid crystal layer, the alignment sustaining layer being configured to regulate a pretilt azimuth of a liquid crystal molecule of the liquid crystal layer when no voltage is applied across the liquid crystal layer; and a seal portion surrounding the liquid crystal layer, wherein the seal portion has a plurality of injection holes in its one side portion for injecting a liquid crystal material into a region surrounded by the seal portion, the plurality of injection holes are three injection holes by which the one side portion of the seal portion is divided into four parts, and where the four parts of the one side portion have length L1, length L2, length L3, and length L4 from one end thereof, the three injection holes are positioned such that each of L2 and L3 is not less than one time respective one of L1 and L4 and is less than two times respective one of L1 and L4.

In a preferred embodiment, the length L1, the length L2, the length L3, and the length L4 of the four parts are generally equal to one another.

In a preferred embodiment, lengths of the plurality of injection holes along a direction in which the one side portion extends are generally equal to one another.

In a preferred embodiment, each of the pair of alignment films is a vertical alignment film, and the liquid crystal layer includes liquid crystal molecules of negative dielectric anisotropy.

### Advantageous Effects of Invention

According to the present invention, a PSA-type liquid crystal display device is provided in which occurrence of display unevenness due to the nonuniformity of the spreading speed of the liquid crystal material during its injection is prevented.

### BRIEF DESCRIPTION OF DRAWINGS

FIG. 1A cross-sectional view schematically showing the structure of one pixel included in a liquid crystal display device 100 of a preferred embodiment of the present invention. (a) shows an alignment of liquid crystal molecules in a black display state (in the absence of an applied voltage). (b) shows an alignment of liquid crystal molecules in a white display state (in the presence of an applied voltage).

FIG. 2 (a) is a top view of the liquid crystal display device 100 of a preferred embodiment of the present invention, which is seen in a direction normal to the substrate. (b) and (c) are cross-sectional views respectively taken along line 2B-2B′ and line 2C-2C′ of (a).

FIG. 3 A diagram which illustrates the relationship between the shape of the spreading liquid crystal material during its injection and occurrence of display unevenness in a comparative liquid crystal display device example 500.

FIG. 4 A diagram which illustrates the relationship between the shape of the spreading liquid crystal material during its injection and occurrence of display unevenness in a comparative liquid crystal display device example 500.

FIG. 5 A diagram which illustrates the relationship between the shape of the spreading liquid crystal material during its injection and occurrence of display unevenness in a comparative liquid crystal display device example 500.

FIG. 6 A diagram which illustrates the relationship between the shape of the spreading liquid crystal material during its injection and occurrence of display unevenness in the liquid crystal display device 100 of a preferred embodiment of the present invention.

FIG. 7 (a) is a top view of another liquid crystal display device 200 of a preferred embodiment of the present invention, which is seen in a direction normal to the substrate. (b) and (c) are cross-sectional views taken along line 7B-7B′ and line 7C-7C′ of (a).

FIG. 8 A diagram which illustrates the relationship between the shape of the spreading liquid crystal material during its injection and occurrence of display unevenness in the liquid crystal display device 200 of a preferred embodiment of the present invention.

FIG. 9 A plan view schematically showing the arrangement of injection holes in a conventional liquid crystal display device 600.

FIG. 10 A diagram schematically illustrating occurrence of display unevenness in the conventional liquid crystal display device 600.

### DESCRIPTION OF EMBODIMENTS

Hereinafter, an embodiment of the present invention will be described with reference to the drawings. Note that the present invention is not limited to the embodiment which will be described below.

[Basic Configuration and Principle of Operation of PSA-Type Liquid Crystal Display Device]

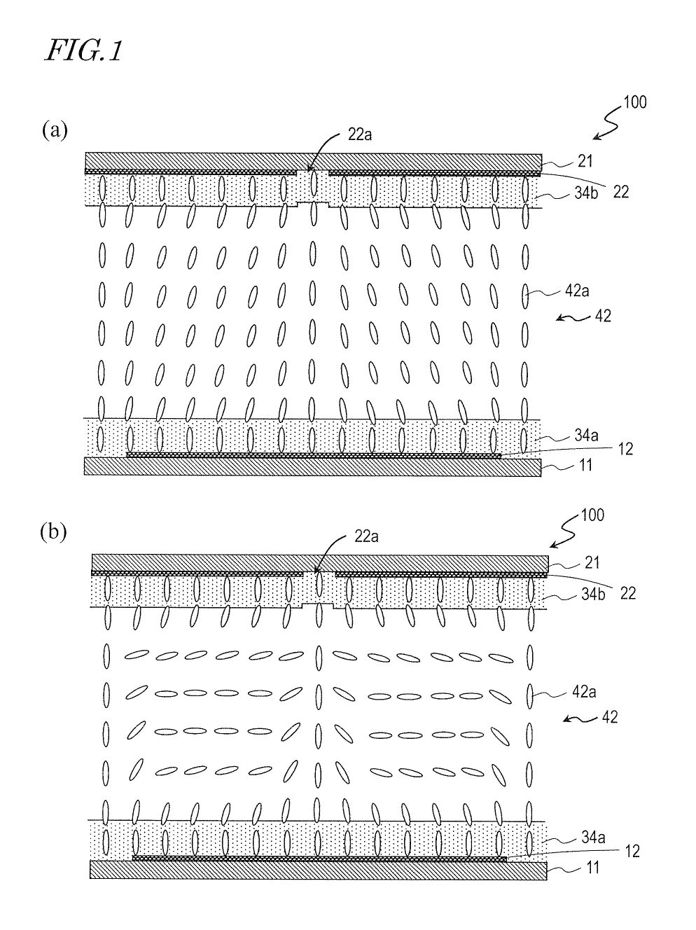

First, the basic configuration and the principle of operation of PSA-type liquid crystal display devices are described with reference to FIG. 1. FIG. 1 is a cross-sectional view schematically showing the structure of one pixel included in a liquid crystal display device 100 of the present embodiment. FIG. 1(a) shows together an alignment of liquid crystal molecules in a black display state (in the absence of an applied voltage). FIG. 1(b) shows together an alignment of liquid crystal molecules in a white display state (in the presence of an applied voltage). Note that the liquid crystal display device 100 shown herein as an example is a vertical alignment (VA) mode liquid crystal display device which is configured to perform display in a normally black mode, to which the present invention is however not limited.

The liquid crystal display device 100 is a liquid crystal display device which includes a pair of substrates 11 and 12 and a pair of polarizing plates (not shown) that are provided on the outer sides of these substrates in a crossed Nicols arrangement, and which is configured to perform display in a normally black mode. Each of the pixels of the liquid crystal display device 100 includes a liquid crystal layer 42 that contains liquid crystal molecules 42a of negative dielectric anisotropy, and a pixel electrode 12 and a counter electrode 22 which oppose each other with the intervention of the liquid crystal layer 42.

A pair of vertical alignment films (not shown) are respectively provided between the pixel electrode 12 and the liquid crystal layer 42 and between the counter electrode 22 and the liquid crystal layer 42. Surfaces of the vertical alignment films which are closer to the liquid crystal layer are respectively provided with a pair of alignment sustaining layers 34a and 34b formed of a photopolymerized material. The alignment sustaining layers 34a and 34b are formed by, after formation of a liquid crystal cell, polymerizing a photopolymerizable compound contained in a prepared liquid crystal material while a voltage is applied across the liquid crystal layer 42. Note that, for the sake of convenience, each of the alignment sustaining layers 34a and 34b in FIG. 1 is shown as a continuous film-like layer. However, the alignment sustaining layers 34a and 34b are not limited to such a form. Each of the alignment sustaining layers 34a and 34b may be constituted of a plurality of pieces (islands) that are discretely formed.

Before the polymerization of the photopolymerizable compound, the alignment of the liquid crystal molecules 42a is controlled by the vertical alignment films (not shown) so that the liquid crystal molecules 42a are oriented vertically to the substrate surface. When a white display voltage is applied, the liquid crystal molecules 42a result in an alignment where they are inclined in predetermined directions according to an oblique electric field generated at an edge portion of the pixel electrode 12 and an oblique electric field generated near an opening 22a of the counter electrode 22 as shown in FIG. 1(b). The alignment sustaining layers 34a and 34b, which are formed under application of the white display voltage, function to sustain (memorize) an alignment of the liquid crystal molecules 42a which occurs under application of the white display voltage across the liquid crystal layer 42 even after removal of the voltage (in the absence of an applied voltage) as shown in FIG. 1(a).

The liquid crystal display device 100 of an embodiment of the present invention has the alignment sustaining layers 34a and 34b and therefore exhibits an alignment of the liquid crystal molecules pretilted in predetermined directions as shown in FIG. 1(a) even in the absence of an applied voltage. The alignment which occurs in this condition conforms to the alignment of the liquid crystal molecules 42a which occurs in a white display state (in the presence of an applied voltage) as shown in FIG. 1(b). As a result, a stable alignment can be achieved, and the response characteristics of the liquid crystal molecules, etc., can be improved.

In the example described herein, an opening 22a (portion not including a conductive layer) is provided in the counter electrode 22 in order to control the orientations of the liquid crystal molecules 42a. However, the method for controlling the orientations of the liquid crystal molecules 42a in the formation of the alignment sustaining layers 34a and 34b is not limited to this example. For example, a protrusion may be provided on the counter electrode 22 instead of the opening 22a. An alignment regulating force produced by an oblique electric field generated at an edge portion of the pixel electrode 12 and an alignment regulating force produced by an opening 22a formed in the counter electrode 22 or the protrusion provided on the counter electrode 22 are used in combination, whereby liquid crystal domains which exhibit, for example, an axially symmetric alignment (radially inclined alignment), can be formed. A vertical alignment mode in which liquid crystal domains of an axially symmetric alignment is formed is referred to as a CPA (Continuous Pinwheel Alignment) mode. The CPA mode is disclosed in, for example, Japanese Laid-Open Patent Publication No. 2002-202511. Another known vertical alignment mode is a MVA (Multi-domain Vertical Alignment) mode such as disclosed in Patent Document 1. The alignment regulating structures for use in the MVA mode (a protrusion provided on the electrode, a slit formed in the electrode, etc.) may be used. In the MVA mode, four liquid crystal domains which have different azimuths of the orientations of the liquid crystal molecules 42a are formed.

The alignment sustaining layers 34a and 34b can be formed according to any of various known methods such as disclosed in Patent Documents 1 and 2 and, for example, can also be formed as described below.

A liquid crystal display panel (liquid crystal cell) for use in the liquid crystal display device 100 is fabricated using a material in which a photopolymerizable compound of a predetermined amount is mixed in a nematic liquid crystal material of negative dielectric anisotropy. The photopolymerizable compound may preferably be a monomer or oligomer which has a radically-polymerizable functional group, such as an acrylate group, a methacrylate group, a vinyl group, or the like. In terms of reactivity, a monomer or oligomer which has an acrylate group or a methacrylate group is more preferable. Among such examples, a polyfunctional group is preferable. By using a material which has a liquid crystal skeleton as the photopolymerizable compound, the alignment of the liquid crystal molecules 42a can be sustained more stably. Especially, a ring system or condensed ring system described in Patent Document 2 to which an acrylate group or a methacrylate group is directly bonded is preferable.

Then, the liquid crystal layer 42 of this liquid crystal display panel (including the above-described photopolymerizable compound) is irradiated with UV light while a predetermined voltage is applied across the liquid crystal layer. Application of the voltage across the liquid crystal layer 42 causes the liquid crystal molecules 42a to have a predetermined alignment according to electric fields generated between the counter electrode 22 and the pixel electrode 12. The UV irradiation causes polymerization of the photopolymerizable compound so that a photopolymerized material is produced. The photopolymerized material forms the alignment sustaining layers 34a and 34b on the vertical alignment films for fixing the above alignment of the liquid crystal molecules 42a. A series of steps for photopolymerizing a photopolymerizable compound while a predetermined voltage which is not lower than the white display voltage is applied to form alignment sustaining layers is sometimes referred to as “PSA process”. In this way, the alignment sustaining layers 34a and 34b can be formed.

[Arrangement of Injection Holes in Seal Portion]

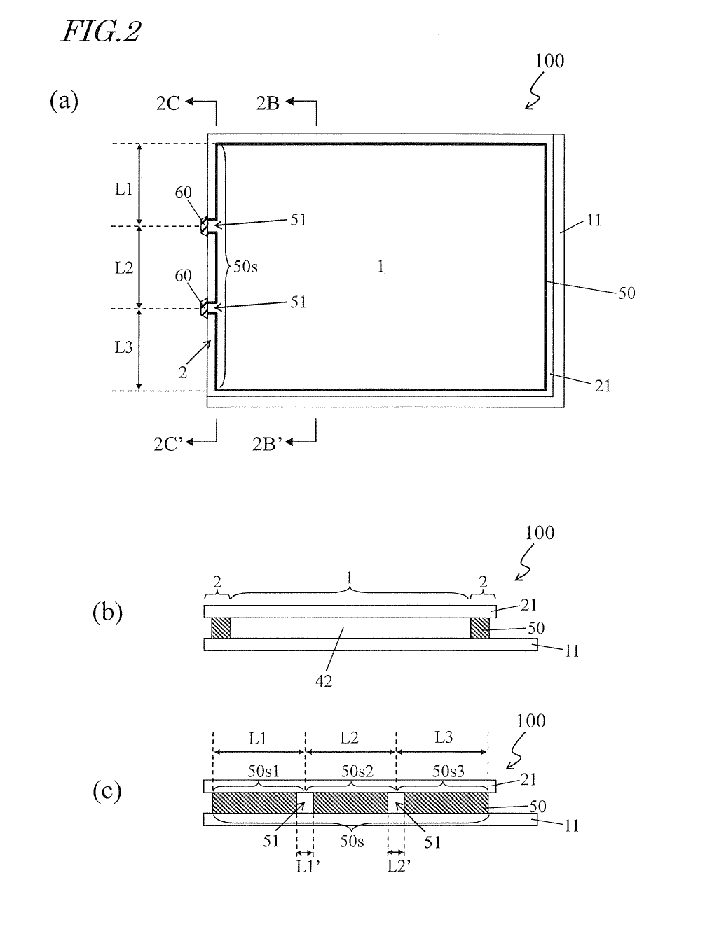

Now, the arrangement of injection holes provided in a seal portion of the liquid crystal display device 100 of the present embodiment is described with reference to FIG. 2. FIG. 2(a) is a top view of the liquid crystal display device 100 which is seen in a direction normal to the substrate. FIG. 2(b) and FIG. 2(c) are cross-sectional views respectively taken along line 2B-2B′ and line 2C-2C′ of FIG. 2(a).

The liquid crystal display device 100 includes a seal portion 50 surrounding the liquid crystal layer 42. The seal portion 50 is provided in a region outside a display region 1 that includes a plurality of pixels, which is referred to as non-display region 2. Typically, the seal portion 50 is formed of a sealant which contains a thermosetting resin (thermosetting sealant) or a sealant which contains a photocurable resin (photocurable sealant).

The seal portion 50 has a plurality of injection holes 51 for injecting a liquid crystal material in a region surrounded by the seal portion 50. The injection holes 51 are provided in a portion of the generally rectangular seal portion 50 corresponding to one side (the left side in FIG. 2(a)), which is hereinafter referred to as one side portion 50s. Each of the injection holes 51 is sealed up by a sealing portion 60.

In the liquid crystal display device 100 of the present embodiment, the plurality of injection holes 51 are two injection holes 51 that are arranged so as to divide the one side portion 50s of the seal portion 50 into three parts 50s1, 50s2, and 50s3 as shown in FIG. 2(c). Where the three parts 50s1, 50s2, and 50s3 have length L1, length L2, and length L3 respectively from one end of the one side portion 50s, the two injection holes 51 are positioned such that L2 is not less than one time the respective one of L1 and L3 and is less than two times the respective one of L1 and L3. FIGS. 2(a) and 2(c) show an example where the length L1, the length L2, and the length L3 of the three parts 50s1, 50s2, and 50s3 are generally equal to one another, i.e., L2 is equal to one time the respective one of L1 and L3. Also, as seen from FIG. 2(c), the lengths of the respective parts, L1, L2, and L3, are defined as the distance from one end of the one side portion 50s to the center of the nearest injection hole 51 or as the distance from the center of one of the injection holes 51 to the center of a neighboring one of the injection holes 51.

In the conventional liquid crystal display device, the arrangement of the plurality of injection holes in the seal portion is not specifically defined but is determined from the viewpoints of (A) shortening the injection time of the liquid crystal material and (B) reducing the amount of the liquid crystal material used. From the viewpoint (A), (1) the plurality of injection holes are arranged at positions such that the spread distances of the liquid crystal material from the respective injection holes are equal, in order to prevent the flows of the spreading liquid crystal material injected from different injection holes from interfering with each other. From the viewpoint (B), (2) the plurality of injection holes are arranged at positions nearer to each other such that the injection of the liquid crystal material can be realized with the use of only one liquid crystal injection tray. Now, consider applying the arrangements (1) and (2) to the case of FIG. 2(c) in which three parts are formed by two injection holes. In the arrangement (1), each of the lengths L1 and L3 of the parts at the both ends is ½ of the length L2 of the middle part (i.e., L2 is two times the respective one of L1 and L3). In the arrangement (2), each of the lengths L1 and L3 of the parts at the both ends is greater than the length L2 of the middle part (i.e., L2 is less than one time the respective one of L1 and L3).

In the liquid crystal display device 100 of the present embodiment, the two injection holes 51 are positioned such that the length L2 of the middle part 50s2 is not less than one time the respective one of the lengths L1 and L3 of the parts 50s1 and 50s3 at the both ends and is less than two times the respective one of the lengths L1 and L3. With such an arrangement of the injection holes 51, occurrence of display unevenness due to the nonuniformity of the spreading speed of the liquid crystal material during its injection can be prevented.

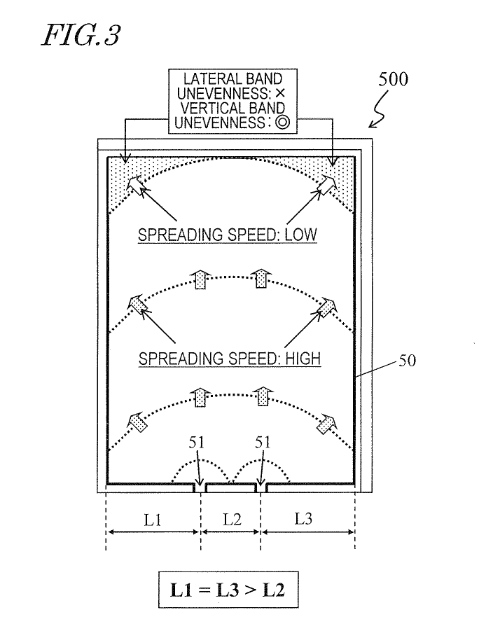

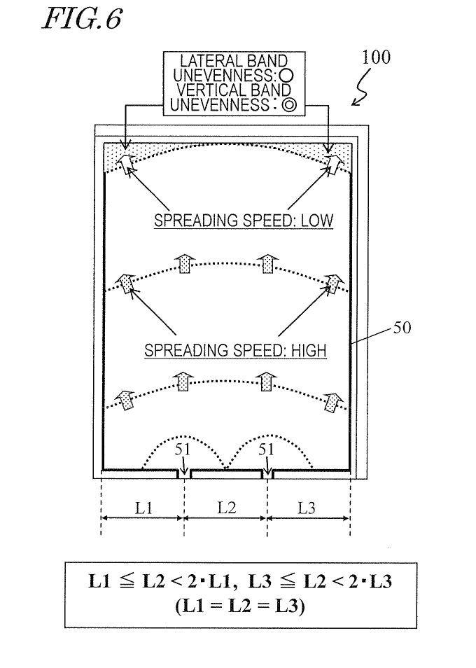

Hereinafter, the grounds of the above arrangement are described with reference to FIG. 3 to FIG. 6. FIG. 3 to FIG. 6 are diagrams which illustrate the relationship between the shape of the spreading liquid crystal material during its injection and occurrence of display unevenness. FIG. 6 corresponds to the liquid crystal display device 100 of the present embodiment. FIG. 3 to FIG. 5 correspond to comparative liquid crystal display device examples 500 in which the injection holes 51 are positioned so as to divide one side portion of the seal portion 50 in different manners from that of the liquid crystal display device 100 of the present embodiment.

In the example shown in FIG. 3, adjacent injection holes 51 are too close to each other, i.e., each of the length L1 of the left part and the length L3 of the right part is greater than the length L2 of the middle part (L1=L3>L2). In this case, a region in which the spreading speed of the liquid crystal material is low is large near the ends of the side opposite to the one side portion that has the injection holes 51 (which is referred to as “opposite side portion”) so that display unevenness disadvantageously occurs in that region. In the specification of the present application, such display unevenness (which is visually perceived in the shape of a laterally extending band as depicted in FIG. 3) is referred to as “lateral band unevenness”.

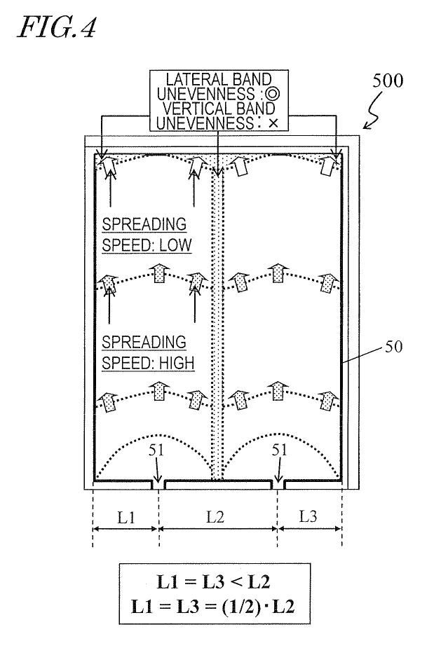

In the example shown in FIG. 4, adjacent injection holes 51 are too far from each other, i.e., each of the length L1 of the left part and the length L3 of the right part is smaller than the length L2 of the middle part and is specifically ½ of L2 (L1=L3<L2; L1=L3=(½)·L2). In this case, a region in which the spreading speed of the liquid crystal material is low is small near the ends and central part of the opposite side portion so that occurrence of the lateral band unevenness can be prevented. However, a region in which the spreading speed of the liquid crystal material converges (the spread distances of the liquid crystal material from the injection holes are equal, and the flows of the liquid crystal material do not mix with each other so that the spreading speed is substantially zero) is large near the midpoint between the adjacent injection holes 51 (in the vicinity of the central part of the display region) so that display unevenness disadvantageously occurs in that region. In the specification of the present application, such display unevenness (which is visually perceived in the shape of a vertically extending band as depicted in FIG. 4) is referred to as “vertical band unevenness”. Note that, in the example of FIG. 3, occurrence of the vertical band unevenness is suppressed.

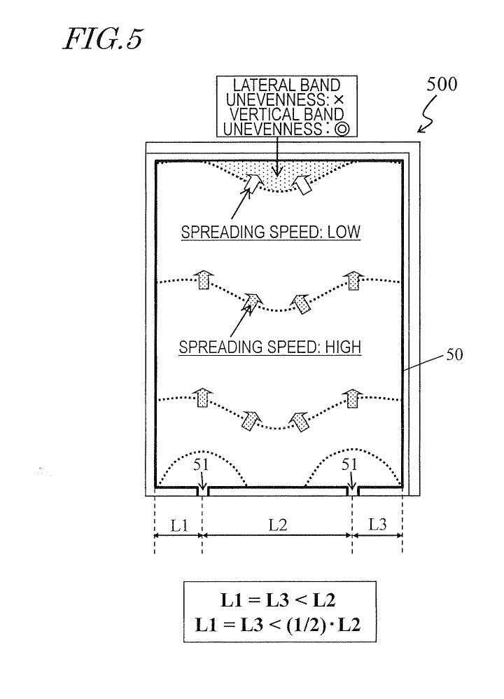

In the example shown in FIG. 5, adjacent injection holes 51 are still far from each other, i.e., each of the length L1 of the left part and the length L3 of the right part is smaller than ½ of the length L2 of the middle part (L1=L3<L2; L1=L3<(½)·L2). In this case, the spread distances of the liquid crystal material from the injection holes are not equal so that occurrence of the vertical band unevenness can be prevented. However, a region in which the spreading speed of the liquid crystal material is low is large near the central part of the opposite side portion so that lateral band unevenness disadvantageously occurs.

On the other hand, in the liquid crystal display device 100 of the present embodiment shown in FIG. 6, two injection holes 51 are positioned such that the length L2 of the middle part 50s2 is not less than one time the respective one of the lengths L1 and L3 of the parts 50s1 and 50s3 at the both ends and is less than two times the respective one of the lengths L1 and L3 (i.e., L1≦L2<2·L1, and L3≦L2<2·L3). In this case, a region in which the spreading speed of the liquid crystal material is low is sufficiently small near the ends of the opposite side portion so that occurrence of lateral band unevenness can be prevented. Also, near the midpoint between the adjacent injection holes 51 (in the vicinity of the central part of the display region 1), the flows of the liquid crystal material injected from the adjacent injection holes 51 mix with each other, so that occurrence of vertical band unevenness can be prevented.

Although FIG. 6 shows an example where the length L1, the length L2, and the length L3 of the three parts 50s1, 50s2, and 50s3 are generally equal to one another and L2 is equal to one time the respective one of L1 and L3 (L1=L2=L3), this example (where two injection holes 51 are positioned so as to divide the one side portion 50s of the seal portion 50 into three parts that are generally equal) is not the only one that can produce the effects of the present invention. The same effects can be achieved so long as L2 is not less than one time the respective one of L1 and L3 and is less than two times the respective one of L1 and L3. Since the spread distances of the liquid crystal material from the injection holes 51 are not equal, the flows of the liquid crystal material injected from the adjacent injection holes 51 mix with each other near the midpoint between the adjacent injection holes 51 (in the vicinity of the central part of the display region 1), so that occurrence of vertical band unevenness can be prevented.

Preferably, the lengths of the plurality of injection holes 51 along the direction in which the one side portion 50s extends, L1′ and L2′ (see FIG. 2(c)), are generally equal. With generally equal lengths of the injection holes 51, substantially equal amounts of the liquid crystal material can be injected from the injection holes 51. Therefore, the nonuniformity of the spreading speed of the liquid crystal material in the display region 1 is averaged, so that occurrence of display unevenness can more surely be prevented.

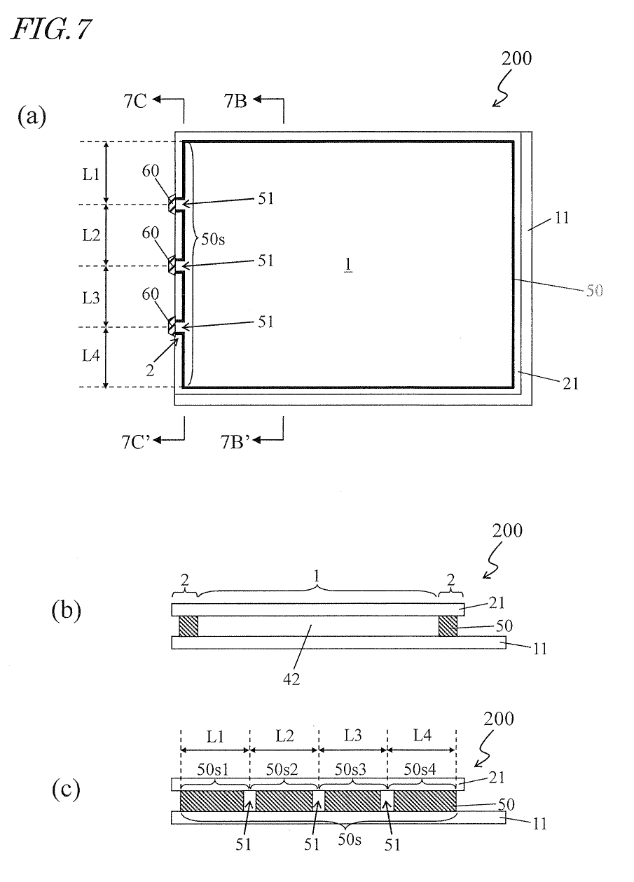

Although in the example described herein the two injection holes 51 are provided in the seal portion 50, three injection holes 51 may be provided such that the one side portion 50s is divided into four parts. FIG. 7 schematically shows another liquid crystal display device 200 of the present embodiment. FIG. 7(a) is a top view of the liquid crystal display device 200 which is seen in a direction normal to the substrate. FIGS. 7(b) and 7(c) are cross-sectional views taken along line 7B-7B′ and line 7C-7C′ of FIG. 7(a).

The seal portion 50 of the liquid crystal display device 200 is different from the liquid crystal display device 100 shown in FIG. 2 in that the one side portion 50s has three injection holes 51. Thus, in the liquid crystal display device 200, the one side portion 50s of the seal portion 50 is divided by the three injection holes 51 into four parts 50s1, 50s2, 50s3, and 50s4. Where the four parts 50s1, 50s2, 50s3, and 50s4 have length L1, length L2, length L3, and length L4, respectively from one end of the one side portion 50s, the three injection holes 51 are positioned such that each of L2 and L3 is not less than one time the respective one of L1 and L4 and is less than two times the respective one of L1 and L4 (i.e., L1≦L2<2·L1, L4≦L2<2·L4, L1≦L3<2·L1, and L4≦L3<2·L4).

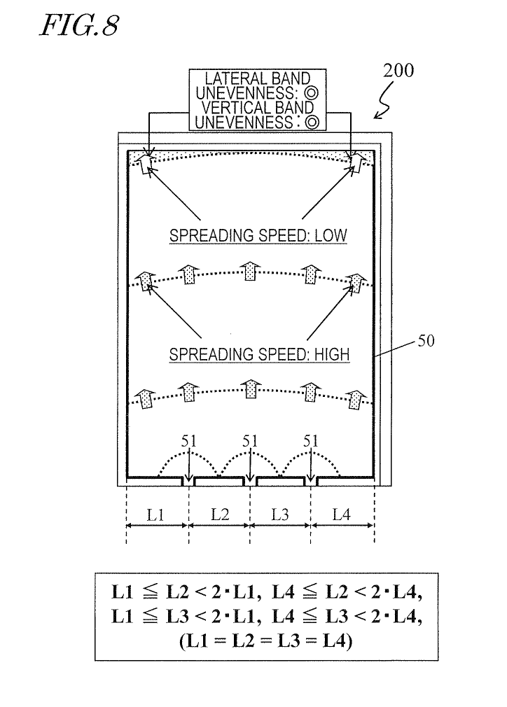

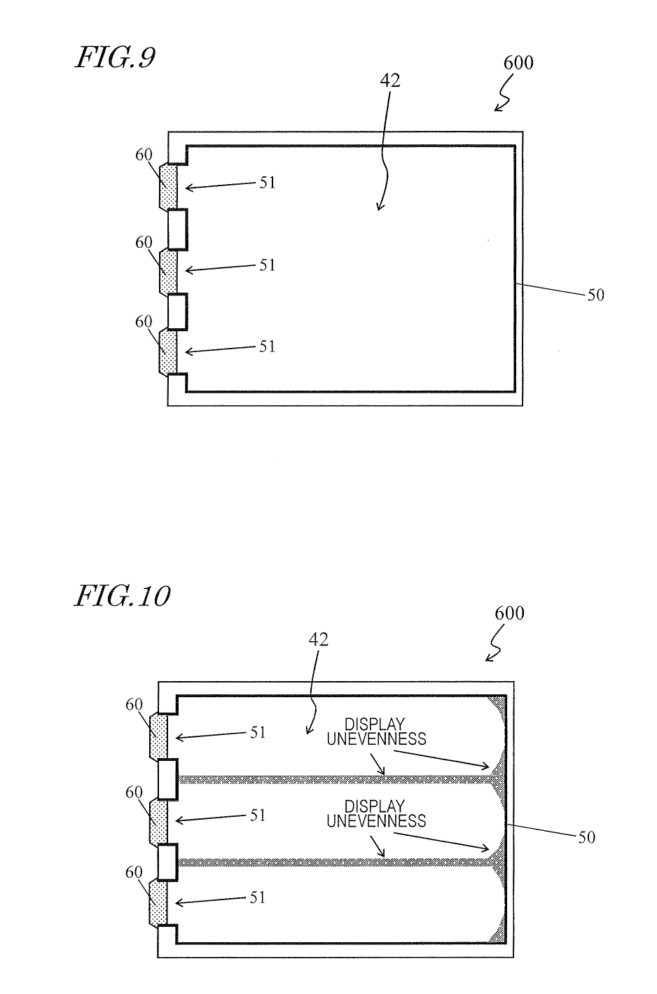

FIG. 8 illustrates the relationship between the shape of the spreading liquid crystal material during its injection and occurrence of display unevenness in the liquid crystal display device 200. In the liquid crystal display device 200, the number of injection holes 51 is greater than in the liquid crystal display device 100, and the one side portion 50s of the seal portion 50 is divided into a larger number of parts. Therefore, the length of each part (the ratio of the length of each part to the length of the one side portion 50s) is smaller. Thus, a region in which the spreading speed of the liquid crystal material is low can be further reduced near the ends of the opposite side portion so that occurrence of lateral band unevenness can more surely be prevented. As a matter of course, occurrence of vertical band unevenness is also prevented.

Although FIG. 8 shows an example where the length L1, the length L2, the length L3, and the length L4 of the four parts 50s1, 50s2, 50s3, and 50s4 are generally equal to one another and each of L2 and L3 is equal to one time the respective one of L1 and L4 (L1=L2=L3=L4), this example (where three injection holes 51 are positioned so as to divide the one side portion 50s of the seal portion 50 into four parts that are generally equal) is not the only one that can produce the effects of the present invention for the same reasons described above in connection with the liquid crystal display device 100. The same effects can be achieved so long as each of L2 and L3 is not less than one time the respective one of L1 and L4 and is less than two times the respective one of L1 and L4.

Note that, when only one injection hole 51 is provided such that the one side portion 50s of the seal portion 50 is divided into two parts, it is difficult to prevent occurrence of display unevenness. Because, in this case, the length of each part (the ratio of the length of each part to the whole length of the one side portion 50s) is large, so that a region in which the spreading speed of the liquid crystal material is low is large near the ends of the opposite side portion so that lateral band unevenness disadvantageously occurs. Occurrence of display unevenness can be prevented by providing two (or three) injection holes 51 such that the one side portion 50s of the seal portion 50 is divided into three (or four) parts and that the length L2 of the middle part 50s2 is not less than one time the respective one of the lengths L1 and L3 of the parts 50s1 and 50s3 at the both ends and is less than two times the respective one of the lengths L1 and L3 (or each of the lengths L2 and L3 of the middle parts 50s2 and 50s3 is not less than one time the respective one of the lengths L1 and L4 of the parts 50s1 and 50s4 at the both ends and is less than two times the respective one of the lengths L1 and L4) as in the liquid crystal display devices 100 and 200 of the present embodiment.

### INDUSTRIAL APPLICABILITY

According to the present invention, a PSA-type liquid crystal display device is provided in which occurrence of display unevenness due to the nonuniformity of the spreading speed of the liquid crystal material during its injection is prevented. The present invention is suitably applicable to various display modes of liquid crystal display devices, especially suitably applicable to liquid crystal display devices of vertical alignment modes, such as CPA mode and MVA mode.

### REFERENCE SIGNS LIST

1 display region
2 non-display region
11, 21 substrate
12 pixel electrode
22 counter electrode
22a opening
34a, 34b alignment sustaining layer
42 liquid crystal layer
42a liquid crystal molecule
50 seal portion
50s one side portion of seal portion
50s1, 50s2, 50s3, 50s4 parts that constitute one side portion
51 injection hole
60 sealing portion
100, 200 liquid crystal display device

1. A liquid crystal display device, comprising:
a liquid crystal layer;
a pair of electrodes opposing each other with the intervention of the liquid crystal layer;
a pair of alignment films which are respectively provided between the pair of electrodes and the liquid crystal layer;
an alignment sustaining layer formed of a photopolymerized material on respective surfaces of the pair of alignment films which are closer to the liquid crystal layer, the alignment sustaining layer being configured to regulate a pretilt azimuth of a liquid crystal molecule of the liquid crystal layer when no voltage is applied across the liquid crystal layer; and
a seal portion surrounding the liquid crystal layer,
wherein the seal portion has a plurality of injection holes in its one side portion for injecting a liquid crystal material into a region surrounded by the seal portion,
the plurality of injection holes are two injection holes by which the one side portion of the seal portion is divided into three parts, and
where the three parts of the one side portion have length L1, length L2, and length L3 from one end thereof, the two injection holes are positioned such that L2 is not less than one time respective one of L1 and L3 and is less than two times respective one of L1 and L3.

2. The liquid crystal display device of claim 1, wherein the length L1, the length L2, and the length L3 of the three parts are generally equal to one another.

3. A liquid crystal display device, comprising:
a liquid crystal layer;
a pair of electrodes opposing each other with the intervention of the liquid crystal layer;
a pair of alignment films which are respectively provided between the pair of electrodes and the liquid crystal layer;
an alignment sustaining layer formed of a photopolymerized material on respective surfaces of the pair of alignment films which are closer to the liquid crystal layer, the alignment sustaining layer being configured to regulate a pretilt azimuth of a liquid crystal molecule of the liquid crystal layer when no voltage is applied across the liquid crystal layer; and
a seal portion surrounding the liquid crystal layer,
wherein the seal portion has a plurality of injection holes in its one side portion for injecting a liquid crystal material into a region surrounded by the seal portion, the plurality of injection holes are three injection holes by which the one side portion of the seal portion is divided into four parts, and
where the four parts of the one side portion have length L1, length L2, length L3, and length L4 from one end thereof, the three injection holes are positioned such that each of L2 and L3 is not less than one time respective one of L1 and L4 and is less than two times respective one of L1 and L4.

4. The liquid crystal display device of claim 3, wherein the length L1, the length L2, the length L3, and the length L4 of the four parts are generally equal to one another.

5. The liquid crystal display device of claim 1, wherein lengths of the plurality of injection holes along a direction in which the one side portion extends are generally equal to one another.

6. The liquid crystal display device of claim 1, wherein
each of the pair of alignment films is a vertical alignment film, and
the liquid crystal layer includes liquid crystal molecules of negative dielectric anisotropy.

7. The liquid crystal display device of claim 3, wherein lengths of the plurality of injection holes along a direction in which the one side portion extends are generally equal to one another.

8. The liquid crystal display device of claim 3, wherein each of the pair of alignment films is a vertical alignment film, and
the liquid crystal layer includes liquid crystal molecules of negative dielectric anisotropy.
